(19) United States
(12) Patent Application Publication
(10) Pub. No.: US 2004/0253526 A1
(43) Pub. Date: Dec. 16, 2004

(54) Manufacturing method for color filter

(76) Inventors: Po-Hsiu Shih, Chung Ho City (TW); Wen-Jen Hsieh, Taipei (TW)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/864,405

(22) Filed: Jun. 10, 2004

(30) Foreign Application Priority Data
Jun. 11, 2003 (TW) 92115901

(51) Int. Cl. G02B 5/20; G02F 1/1335

(52) U.S. Cl. 430/7; 347/106

(57) ABSTRACT

A manufacturing method for color filters is described. The manufacturing method is utilized to produce color filters of liquid crystal displays. The manufacturing method has following steps. First, a glass substrate is provided. Subsequently, a light shield layer and a photoresist layer are formed on the glass substrate and patterned. An inkjet technology is utilized to color the glass substrate. Finally, the photoresist layer is removed and a transparently conductive layer is formed thereon. The light shield layer is made of a resin, a metal chromium or a chromium oxide.

### FIELD OF THE INVENTION

The present invention relates to a manufacturing method for color filters, and more particularly, to a manufacturing method for color filters by an inkjet technology for liquid crystal displays.

### BACKGROUND OF THE INVENTION

Recently, liquid crystal displays (LCD) have been widely applied in electrical products, due to the rapid progress of optical technology and semiconductor technology.

Moreover, with the advantages of high image quality, compact size, light weight, low driving voltage, and low power consumption, LCDs have been introduced into portable computers, personal digital assistants, and color televisions, and have gradually replaced the cathode ray tubes (CRT) used for conventional displays. LCDs are becoming the mainstream display apparatus.

The main part of an LCD is a liquid crystal (LC) unit having two parallel transparent substrates with LC sealed therein. The main trend for LCDs is the thin film transistor (TFT) LCD. The fabrication processes of a TFT-LCD can be divided into four parts: TFT array process, color filter (CF) process, LC cell assembly process, and liquid crystal module (LCM) process.

The TFT array process is used to fabricate a TFT substrate. Each TFT respectively aligns with one pixel electrode. The CF process is used to fabricate a color filter substrate. A color filter layer composed of different color filter sheets is located on the color filter substrate, and a black matrix layer surrounds each color filter sheet.

The LC cell assembly process is used to parallel-assemble TFT substrate and CF substrate, and bead spacers are spread between them to maintain a fixed distance, i.e. a cell gap, between TFT substrate and CF substrate. LC is injected into the cell gap and then the injection opening is sealed. Basically, each pixel electrode respectively corresponds to one color filter sheet, and the black matrix layer covers TFTs and metal lines that connect different TFTs. Generally, the direction of liquid crystal molecule axes, which are controlled by TFT, determines whether each pixel is pervious to light or not. The color of each pixel is determined by the color of color filter sheet. For example, when light passes through a red color filter sheet, a red spot is shown on the panel. Mixing red, green and blue colors can show full-color images.

A conventional manufacturing method for the color filters uses a large number of dyes with very complicated processes for manufacturing the color filter substrate with RGB colors. Therefore, a manufacturing method for color filters has been developed. A traditional manufacturing method for color filters can solve alignment errors of a large TFT-LCD and color different dyes on respective positions of the color filter substrate to form the respective color filter sheets thereon.

Because the color ink is a liquid material, an isolation wall surrounding the ink for limiting the color inks to a predetermined area is necessary. However, a thickness of the isolation wall can influence a thickness of the color filter substrate. Furthermore, a surface tension between the ink and the isolation wall can influence the quality of the color filters, and therefore the conventional manufacturing method for color filters has to limit materials of the isolation wall and the inks for making the color filter, and furthermore complicates the manufacture process thereof.

### SUMMARY OF THE INVENTION

It is an object of the present invention to provide a manufacturing method for an color filter to improve the coloring efficiency of a color filter substrate.

It is another object of the present invention is to improve an isolation wall of a color filter substrate so as to improve a thickness of the color filter substrate.

It is yet another object of the present invention is to remove a photoresist layer after color inks are solidified on the color filter substrate so that dye contaminations can be simultaneously removed.

To accomplish the above objectives, the present invention provides a manufacturing method for color filters. The manufacturing method includes the following steps. First, a glass substrate is provided. Then, a light shield layer and a photoresist layer are sequentially formed thereon. The light shield layer and the photoresist layer are patterned by an etching process to form a plurality of openings.

Color inks are then injected on the plurality of openings to form color filter sheets by an inkjet technology. The color filter sheets include red, green, and blue color filter sheets. Subsequently, the photoresist layer is removed and a transparent conductive layer is then formed thereon.

The light shield layer is a light shield layer made of a resin, a metal chromium and a chromium oxide, and is patterned to form a black matrix. The photoresist layer is a positive photoresist layer and is removed by a photoresist stripper or any other photoresist stripping process after the glass substrate is colored.

Hence, the manufacturing method for color filters according to the present invention can enhance the position precision of the color filter, reduce repeated coloring of the color filter, and furthermore eliminates the influence of the isolation wall thickness on the thickness of the color filter.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIGS. 1A to 1I are schematic cross-sectional views of one embodiment of the manufacturing method for color filter according to the present invention; and

FIGS. 2A to 2I are schematic cross-sectional views of another embodiment of the manufacturing method for color filter according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

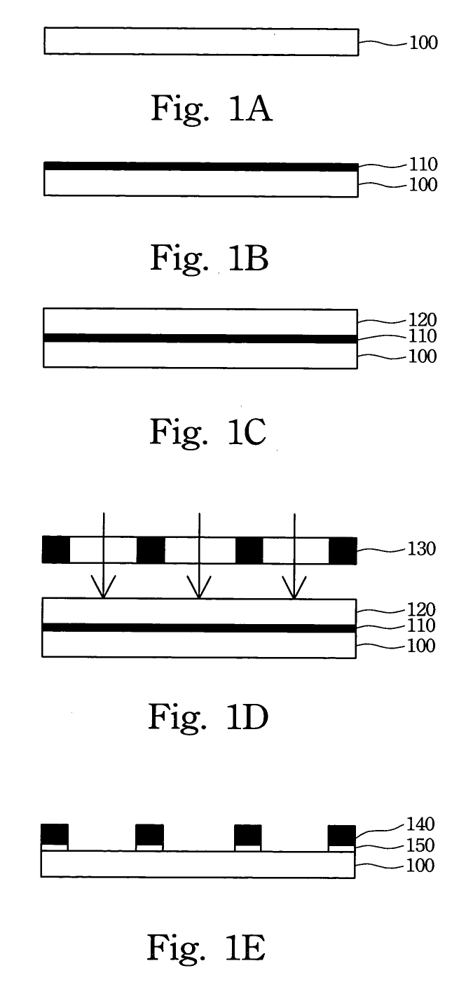

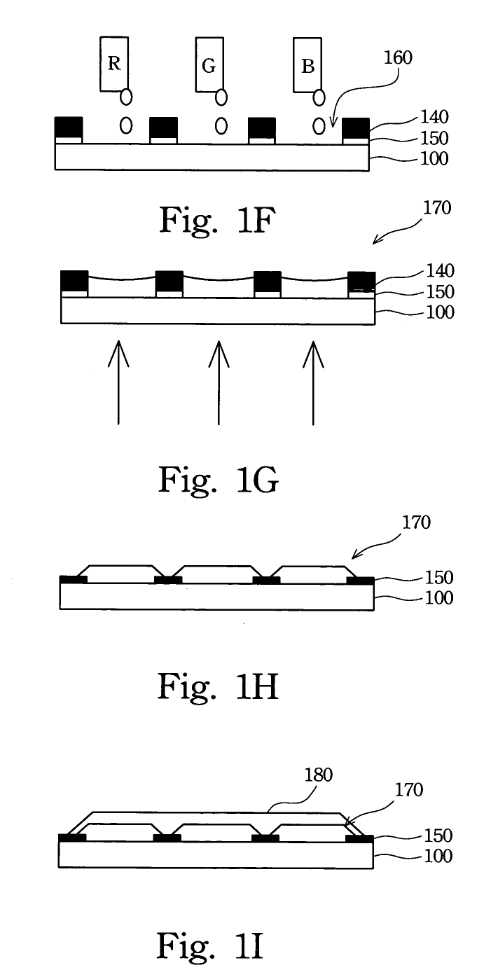

FIGS. 1A to 1I are schematic cross-sectional views of one embodiment of the manufacturing method for color filter according to the present invention. The embodiment utilizes a metal chromium (Cr) to form a light shield layer, e.g. a black matrix (BM).

First, referring to FIG. 1A to FIG. 1E, a glass substrate 100 is provided and subsequently a metal chromium layer 110 and a positive photoresist layer 120 are formed thereon. Then, the positive photoresist layer 120 and the metal chromium layer 110 are patterned by an etching process through the photo mask 130 to form a plurality of openings 160 in a patterned positive photoresist layer 140 and a patterned metal chromium layer 150.

Referring to FIG. 1F to FIG. 1G, red, green, and blue color inks are injected into the patterned positive photoresist layer 140 and the patterned metal chromium layer 150. Then, the color inks are solidified therein by a heating process to evaporate solvents of the color inks and form a color filter layer 170. The steps of FIG. 1F to FIG. 1G are repeated until a thickness of the color filter layer 170 reaches a predetermined thickness.

Referring to FIG. 1H to FIG. 1I, the patterned positive photoresist layer 140 is removed by a photoresist stripper or any other stripping process. Subsequently, a transparent conductive layer 180 is formed on the color filter layer 170. The transparent conductive layer 180 is formed of a transparent material, e.g. indium tin oxide (ITO), zinc oxide (ZnO), cadmium tin oxide (CTO), indium zinc oxide (IZO), zirconium oxide (ZrO₂), aluminum zinc oxide, or a combination thereof.

The manufacturing method for color filters according to the present invention utilizes the patterned positive photoresist layer 140 to construct an isolation wall for the color inks. The patterned positive photoresist layer 140 is then removed after the color inks are solidified and the color filter layer 170 are formed. Therefore, the isolation wall formed by the patterned positive photoresist layer 140 may be higher than a conventional isolation wall. In particular, the thickness of the patterned positive photoresist layer 140 can be adjusted according to actual requirements without influencing color filter substrate thickness and furthermore color ink thickness.

Normally, the color inks include about 20% dye and while the other part is almost all solvents. Therefore, a repeat color coating process is necessary to reach the predetermined thickness of the color filter layer 170. The present invention utilizes the patterned positive photoresist layer 140 and the patterned metal chromium layer 150 to form a higher isolation wall so that the number of repeat times, color inks injection and solidification, can be efficiently reduced and therefore the color filter layer 170 can be formed more efficiently. Furthermore, because the patterned positive photoresist layer 140 is removed after the color filter layer 170 is formed, the thickness of the patterned positive photoresist layer 140 does not influence the thickness of the color filter layer 170 and the final product thereof. Accordingly, the thickness of the photoresist layer can be adjusted according to actual requirements.

In the manufacture of a conventional color filter, the color inks may pollute the color filter layer when the color inks spill out of the isolation wall. The manufacturing method for color filters according to the present invention provides a higher isolation wall and removes the color ink attached to the photoresist layer when the photoresist layer is removed. In the meantime, the shape of the color filter sheet can be further modified at the photoresist stripping process and therefore the color filter contaminations can be simultaneously cleaned.

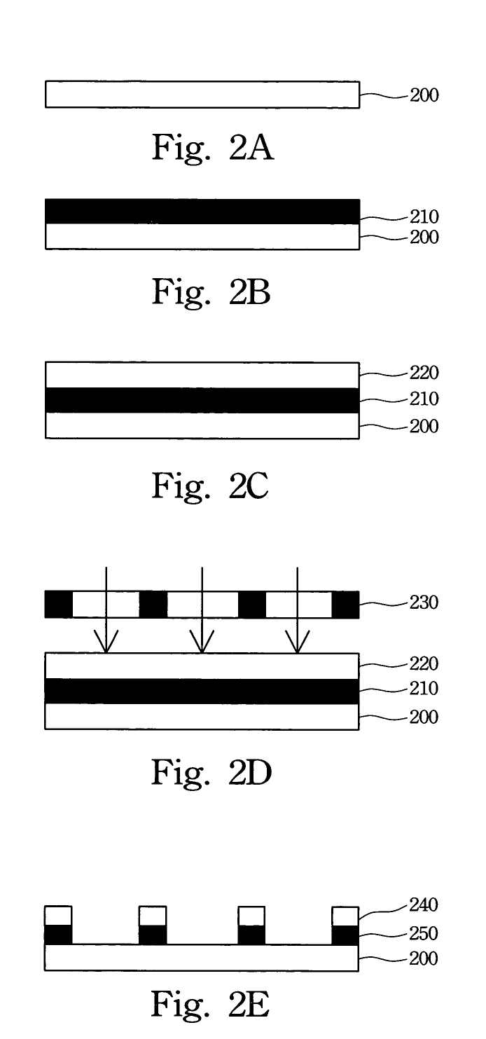

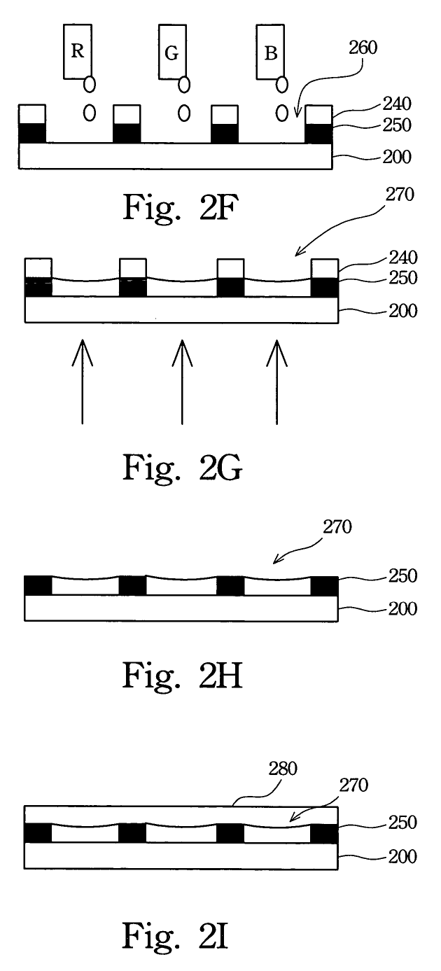

FIG. 2A to FIG. 2I are schematic cross-sectional views of another embodiment of the manufacturing method for color filter according to the present invention. The another embodiment utilizes a black matrix made of resins to prevent light from passing through.

First, referring to FIG. 2A to 2E, a glass substrate 200 is provided and subsequently a resin layer 210 and the positive photoresist layer 220 are formed thereon. Then, the positive photoresist layer 220 and the resin layer 210 are patterned by an etching process with a photo mask 230 to form a plurality of openings 260 in a patterned positive photoresist layer 240 and a patterned resin layer 250.

Then, referred to FIG. 2F to FIG. 2G, RGB color inks are injected on the plurality of openings 260. Subsequently, the color inks are solidified in a heating process that evaporates the solvent in the color inks to form a color filter layer 270. The steps illustrated in FIG. 2F to FIG. 2G are repeated until a thickness of the color filter layer 270 reaches a predetermined thickness.

Afterwards, referring to FIG. 2H to FIG. 2I, the patterned positive photoresist layer 240 is removed by a photoresist stripper or any other stripping processe. Then, a transparent conductive layer 280 is formed on the color filter layer 270. The transparent conductive layer 280 is also indium tin oxide (ITO), zinc oxide (ZnO), cadmium tin oxide (CTO), indium zinc oxide (IZO), zirconium oxide (ZrO2), aluminum zinc oxide, or combination layers thereof.

The manufacturing method for color filter according to the present invention utilizes the patterned positive photoresist layer 240 to form the isolation wall for the color inks, and the patterned positive photoresist layer 240 can be removed after the color filter layer 270 is formed. Therefore, the isolation wall, the patterned positive photoresist layer 240, can be thicker than a conventional isolation wall for color inks. Furthermore, the thickness of the isolation wall can be adjusted according to practical requirements without influencing the final product thickness. Accordingly, the coloring efficiency and quality of the color filter are therefore efficiently increased.

According to the foregoing description, the black matrix can be made of metal chromium, resin, or chromium oxide. The present invention can use any suitable material to form the black matrix and any suitable color inks to form the color filters. The patterned photoresist layer is removed after the black matrix is formed and the color ink is fixed therein. Hence, the manufacturing quality and efficiency of the color filter are apparently increased.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

What is claimed is:

1. A manufacturing method for color filters, the manufacturing method comprising:
providing a glass substrate;
forming a light shield layer;
forming a photoresist layer;
patterning the light shield layer and the photoresist layer to form a plurality of openings;
injecting color ink on the plurality of openings;
removing the photoresist layer; and
forming a transparent conductive layer.

2. The manufacturing method for claim 1, wherein the light shield layer comprises a resin light shield layer.

3. The manufacturing method for claim 1, wherein the light shield layer comprises a metal chromium light shield layer.

4. The manufacturing method for claim 1, wherein the light shield layer comprises a chromium oxide light shield layer.

5. The manufacturing method for claim 1, wherein the step of patterning the light shield layer is utilized to form a black matrix.

6. The manufacturing method for claim 1, wherein the photoresist is a positive photoresist layer.

7. The manufacturing method for claim 1, wherein the transparent conductive layer comprises an indium tin oxide (ITO) layer.

8. The manufacturing method for claim 1, wherein the transparent conductive layer comprises a zinc oxide (ZnO) layer.

9. A manufacturing method for color filters, the manufacturing method comprising:
providing a glass substrate;
forming a metal chromium light shield layer;
forming a photoresist layer;
patterning the metal chromium light shield layer and the photoresist layer to form a plurality of openings;
injecting color ink on the plurality of openings;
removing the photoresist layer; and
forming a transparent conductive layer.

10. The manufacturing method for claim 9, wherein the step of patterning the metal chromium light shield layer is utilized to form a black matrix.

11. The manufacturing method for claim 9, wherein the photoresist is a positive photoresist layer.

12. The manufacturing method for claim 11, wherein the step of removing the photoresist layer utilizes a photoresist stripper to remove the positive photoresist layer.

13. The manufacturing method for claim 9, wherein the transparent conductive layer comprises a zinc oxide (ZnO) layer.

14. The manufacturing method for claim 9, wherein the transparent conductive layer comprises a zinc oxide (ZnO) layer.

15. A manufacturing method for color filters, the manufacturing method comprising:
providing a glass substrate;
forming a resin light shield layer;
forming a photoresist layer;
patterning the resin light shield layer and the photoresist layer to form a plurality of openings;
injecting color ink on the plurality of openings;
removing the photoresist layer; and
forming a transparent conductive layer.

16. The manufacturing method for claim 15, wherein the step of patterning the resin light shield layer is utilized to form a black matrix.

17. The manufacturing method for claim 15, wherein the photoresist is a positive photoresist layer.

18. The manufacturing method for claim 17, wherein the step of removing the photoresist layer utilizes a photoresist stripper to remove the positive photoresist layer.

19. The manufacturing method for claim 15, wherein the transparent conductive layer comprises a zinc oxide (ZnO) layer.

20. The manufacturing method for claim 15, wherein the transparent conductive layer comprises a zinc oxide (ZnO) layer.
